(19) United States
(12) Patent Application Publication
(10) Pub. No.: US 2024/0010853 A1
(43) Pub. Date: Jan. 11, 2024

(54) COATING COMPOSITION AND COATED ARTICLE INCLUDING COATING FORMED BY THE COATING COMPOSITION

(71) Applicant: GUANGDONG HUARUN PAINTS CO., LTD., Foshan City (CN)

(72) Inventors: Hongbin Chen, Foshan City (CN); Jun Zhang, Foshan City (CN); Weichang Du, Foshan City (CN)

(21) Appl. No.: 18/042,321

(22) PCT Filed: Aug. 19, 2021
(86) PCT No.: PCT/CN2021/113590

§ 371 Date: Feb. 21, 2023

(30) Foreign Application Priority Data
Aug. 21, 2020 (CN) 202010847136.1

(51) Int. Cl. C09D 7/63; C09D 5/00

(52) U.S. Cl. CPC C09D 7/63; C09D 5/00; C08K 5/3475

(57) ABSTRACT

The present application relates to a coating composition and a coated article including a coating formed by the coating composition. The coating composition described herein includes at least one film-forming resin, at least one co-solvent and at least one additive, wherein the at least one additive includes at least one fused aza-heterocyclic compound or at least one aza-heterocyclic compound substituted with at least one aromatic group, and the fused aza-heterocyclic compound or the aza-heterocyclic compound substituted with at least one aromatic group having a ring containing at least one —NH— bond. The coating composition described herein can form a dense film with excellent hardness, chemical resistance and/or water resistance.

### TECHNICAL FIELD

The present application relates to a coating composition. Specifically, the present application relates to a coating composition capable of forming a dense film, and to a coated article comprising a coating formed by the coating composition

### BACKGROUND

In the coating industry, crosslinking agents are widely used to accelerate the crosslinking of polymers and improve the hardness, chemical resistance and water resistance of film. However, at present, the commonly used curing agents include sensitizing substances, such as aziridine.

With people's increasing attention to health and environmental protection, it is increasingly desirable to reduce or even avoid the use of sensitizing substances in coatings is. However, reducing or avoiding the use of sensitizing substances such as aziridine will lead to obvious deterioration of film performance, especially chemical resistance and water resistance.

In order to form a dense film and reduce the use of sensitizing substances, some existing solutions use very complex functional monomers or special resin particle structures to design the film-forming resin, so as to obtain a dense film. However, these solutions not only involve complex resin synthesis process, but also have low output, difficulty to control product quality and a narrow scope of applications, so they have high cost and are not suitable for industrial production and application. Technicians also design some modified curing agents to inhibit sensitization. However, these modified curing agents have complex synthesis process and high production cost, which greatly limits the scope and prospect of applications in the market.

### SUMMARY

Therefore, there is still a need in the coating industry for an improved coating composition that is capable of forming a dense film having excellent resistance and contains less or even no sensitizing substances.

The above objective can be achieved by the coating composition described herein.

A first aspect of the present application provides a coating composition, comprising at least one film-forming resin, at least one co-solvent, and at least one additive, wherein the at least one additive includes at least one fused aza-heterocyclic compound or at least one aza-heterocyclic compound substituted with at least one aromatic group, and the fused aza-heterocyclic compound or the aza-heterocyclic compound substituted with at least one aromatic group has a ring containing at least one —NH— bond.

A second aspect of the present application provides a multi-component coating composition, comprising: A) the coating composition according to any one of claims 1 to 8; and B) at least one crosslinking agent.

A third aspect of the present application provides a coated article, comprising a substrate; and the coating composition as described herein or a cured coating formed by the coating composition, coated on the substrate.

The present application also provides use of the at least one fused aza-heterocyclic compound or the at least one aza-heterocyclic compound substituted with the at least one aromatic group in a coating composition. The film formed by the coating composition of the present application has excellent denseness (compactness), chemical resistance and/or water resistance.

It has been found that the coating composition containing the at least one fused aza-heterocyclic compound or the at least one aza-heterocyclic compound substituted with the at least one aromatic group described herein can form a dense film and improve chemical resistance and/or water resistance of the film. Moreover, the at least one fused aza-heterocyclic compound or the at least one aza-heterocyclic compound substituted with at least one aromatic group described herein is a non-sensitizing substance. Therefore, with the help of the coating composition described herein, the use of sensitizing substances can be reduced or even avoided, and meanwhile chemical and/or water resistance may be improved. This is very surprising.

In addition, the technical embodiments of the application may also have further advantages such as simple operation, safety, effectiveness and low cost.

The details of one or more embodiments of the application will be set forth in the description below. The other features, objectives, and advantages of the invention will become apparent.

### DETAILED DESCRIPTION

### Definition

As used herein, “a”, “an”, “the”, “at least one”, and “one or more” are used interchangeably. Thus, for example, a coating composition that comprises “an” additive can be interpreted to mean that the coating composition includes “one or more” additives. As used herein, the singular forms are intended to include the plural forms as well, unless the context clearly indicates otherwise.

Throughout the present application, where compositions are described as having, including, or comprising specific components or fractions, or where processes are described as having, including, or comprising specific process steps, it is contemplated that the compositions or processes as disclosed herein may further comprise other components or fractions or steps, whether or not, specifically mentioned in this invention, as along as such components or steps do not affect the basic and novel characteristics of the invention, but it is also contemplated that the compositions or processes may consist essentially of, or consist of, the recited components or steps.

For the sake of brevity, only certain ranges are explicitly disclosed herein. However, it should be understood that any lower limit may be combined with any upper limit to recite a range not explicitly recited, as well as, any lower limit may be combined with any other lower limit to recite a range not explicitly recited, in the same way, any upper limit may be combined with any other upper limit to recite a range not explicitly recited.

Unless otherwise indicated, the recitations of numerical ranges by endpoints include all numbers subsumed within that range. For example, a range of from 1 to 5 includes 1, 1.5, 2, 2.75, 3, 3.80, 4, 5, etc. Furthermore, disclosure of a range includes disclosure of all subranges included within the broader range. For example, a range of from 1 to 5 discloses the subranges of from 1 to 4, from 1.5 to 4.5, from 1 to 2, etc. Thus, every point or individual value may serve as a lower or upper limit combined with any other point or individual value or any other lower or upper limit, to recite a range explicitly recited in the present application.

In the context of describing that a composition does not contain or is free of an ingredient, the phrases “does not contain” and “is free of” mean that the composition does not contain the ingredient intentionally added. Under the consideration of the complexity of components of a specific composition in the actual preparation process, the phrases “does not contain a certain component” and “is free of a certain component” can be understood to mean that the composition contains less than 1 wt. % (weight %) of the component, less than 0.5 wt. %, less than 0.2 wt. %, less than 0.1 wt. % of the component, relative to total weight of the composition.

The coating composition described herein may be mono-component or multi-component. In the context of a “multi-component” coating composition, the term “multi-component” means that the coating composition includes two or more components stored or packaged separately and then mixed together before being applied to the substrate. In some embodiments of the invention, the multi-component coating composition consists of two components, namely, a two-component coating composition.

The coating composition described herein may be an “aqueous” coating composition. The term “aqueous” means that the solvent or carrier fluid of the coating composition mainly or primarily contains water. For example, in some embodiments, the solvent or carrier fluid comprises at least about 50 wt. %, at least about 60 wt. %, at least 70 wt. %, and up to about 100 wt. % of water based on the total weight of the solvent or carrier fluid. For example, based on the total weight of the solvent or carrier fluid, the solvent or carrier fluid contains about 80 wt. %, about 85 wt. %, or about 90 wt. % of water.

“Sensitizing substance” as used herein refers to a substance that may cause sensitization through skin contact. In particular, “sensitizing substance” is a substance with “sensitizing effect” clearly recorded in its chemical material safety data sheet (MSDS). Examples of sensitizing substance include aziridine and substances with similar structures.

The term “dispersion” herein conforms to the definition in the IUPAC Compendium of Chemical Terminology (2007), which defines a dispersion to be a material comprising more than one phase, where at least one of the phases consists of finely divided phase domains, often in the colloidal size range, distributed throughout a continuous phase domain.

As used herein, the term “aqueous dispersion comprising polymer particles” refers to a stable dispersion of synthetic resin (i.e., polymer) in the form of particles in an aqueous liquid medium, optionally with the aid of suitable dispersion aids such as surfactants, co-solvents. Therefore, in the present application, when used for polymers, unless otherwise stated, the terms “aqueous latex” and “aqueous dispersion” may be used alternately. Aqueous latex may be prepared by methods known in the field, for example, by emulsion polymerization process known by technicians in this field. Suitable emulsion polymerization processes are well known to a person skilled in the art, and generally include the steps of: dispersing and emulsifying polymerizable monomers in water with the aid of, as appropriate, an emulsifier and/or a dispersion stabilizer under agitation; and initiating polymerization of the monomers, e.g., by adding an initiator. In the present disclosure, the polymeric particles can be modified by, for example, incorporating therein some organic functional groups including, but not limited thereto, carboxyl, hydroxyl, amino, isocyanate, sulphonic group or the like, whereby the aqueous latex can be obtained with desirable properties such as dispersability. Therefore, as used herein, the term “aqueous latex” or “aqueous dispersion” as used herein encompasses not only a dispersion or latex of unmodified polymeric particles in an aqueous medium, but also a dispersion or latex of organo-functional modified polymeric particles in an aqueous medium.

The term “alkyl” as used herein means a straight or branched chain hydrocarbon containing from 1 to 10 carbon atoms, and preferably 1, 2, 3, 4, 5, or 6 carbons. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl. Each of the carbon atoms of the alkyl group is substituted with 0, 1, or 2 substituents selected from acyl, acyloxy, alkoxy, alkoxyalkoxy, alkoxyalkyl, alkoxycarbonyl, alkoxyimino, alkoxysulfonyl, alkylcarbonyl, alkylsulfonyl, amido, carboxy, cyano, cycloalkyl, fluoroalkoxy, formyl, haloalkoxy, haloalkyl, halogen, hydroxy, hydroxyalkyl, mercapto, nitro, oxo and alkylthio.

The term “alkylamino” as used herein means an alkyl group, as defined herein, appended to the parent molecular moiety through a NH group. Representative examples of alkylamino include, but are not limited to, methylamino, ethylamino, isopropylamino, and butylamino.

The term “alkylcarbonyl” as used herein means an alkyl group, as defined herein, appended to the parent molecular moiety through a carbonyl group. Representative examples of alkylcarbonyl include, but are not limited to, methylcarbonyl, ethylcarbonyl, isopropylcarbonyl, n-propylcarbonyl, and the like.

The term “alkylsulfonyl” as used herein means an alkyl group, as defined herein, appended to the parent molecular moiety through a sulfonyl group. Representative examples of alkylsulfonyl include, but are not limited to, methylsulfonyl and ethylsulfonyl.

The term “alkoxy” as used herein means an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy.

The term “alkoxycarbonyl” as used herein means an alkoxy group, as defined herein, appended to the parent molecular moiety through a carbonyl group, as defined herein. Representative examples of alkoxycarbonyl include, but are not limited to, methoxycarbonyl, ethoxycarbonyl, isopropoxycarbonyl, and tert-butoxy carbonyl.

The term “alkoxyalkyl” as used herein means an alkoxy group, as defined herein, appended to the parent molecular moiety through an alkyl group, as defined herein. Representative examples of alkoxyalkyl include, but are not limited to, tert-butoxymethyl, 2-ethoxyethyl, 2-methoxyethyl, and methoxymethyl.

The term “cycloalkyl” as used herein means a saturated cyclic hydrocarbon group containing from 3 to 8 carbons. Examples of cycloalkyl include cyclopropyl, cyclobutyl, cyclopentyl, cyclohexyl, cycloheptyl, and cyclooctyl. Each of the carbon atoms of the cycloalkyl groups is substituted with 0, 1, or 2 substituents selected from acyl, acyloxy, alkenyl, alkoxy, alkoxyalkoxy, alkoxyalkyl, alkoxycarbonyl, alkoxyimino, alkoxysulfonyl, alkyl, alkylcarbonyl, alkylsulfonyl, alkynyl, amido, carboxy, cyano, cycloalkyl, fluoroalkoxy, formyl, haloalkoxy, haloalkyl, halogen, hydroxy, hydroxyalkyl, mercapto, nitro, and alkylthio.

The term “acyl” as used herein means an alkyl group, as defined herein, appended to the parent molecular moiety through a carbonyl group, as defined herein. Representative examples of acyl include, but are not limited to, acetyl, 1-oxopropyl, 2,2-dimethyl-1-oxopropyl, 1-oxobutyl, and 1-oxopentyl.

The term “halo” or “halogen” as used herein means Cl, Br, I, or F.

The term “haloalkyl” as used herein means at least one halogen, as defined herein, appended to the parent molecular moiety through an alkyl group, as defined herein. Representative examples of haloalkyl include, but are not limited to, chloromethyl, 2-fluoroethyl, trifluoromethyl, pentafluoroethyl, and 2-chloro-3-fluoropentyl.

The term “haloalkoxy” as used herein means at least one halogen, as defined herein, appended to the parent molecular moiety through an alkoxy, as defined herein. Representative examples of haloalkoxy include, but are not limited to, 2-fluoroethoxy, trifluoromethoxy, and pentafluoroethoxy.

The term “aryl” as used herein means phenyl, a bicyclic aryl, or a tricyclic aryl. The bicyclic aryl is attached to the parent molecular moiety through any carbon atom contained within the bicyclic aryl. Representative examples of the bicyclic aryl include, but are not limited to, dihydroindenyl, indenyl, naphthyl, dihydronaphthalenyl, and tetrahydronaphthalenyl. The tricyclic aryl is a tricyclic aryl ring system such as anthracene or phenanthrene, a bicyclic aryl fused to a cycloalkyl, a bicyclic aryl fused to a cycloalkenyl, or a bicyclic aryl fused to a phenyl. The tricyclic aryl is attached to the parent molecular moiety through any carbon atom contained within the tricyclic aryl. Representative examples of tricyclic aryl ring include, but are not limited to, anthracenyl, phenanthrenyl, azulenyl, dihydroanthracenyl, fluorenyl, and tetrahydrophenanthrenyl.

The carbon atoms of the aryl groups may be optionally substituted with one or more substituents independently selected from acyl, acyloxy, alkenyl, alkoxy, alkoxyalkoxy, alkoxyalkyl, alkoxycarbonyl, alkoxyimino, alkoxysulfonyl, alkyl, alkylcarbonyl, alkyl sulfonyl, alkynyl, amido, carboxy, cyano, cycloalkyl, fluoroalkoxy, formyl, haloalkoxy, haloalkyl, halogen, hydroxy, hydroxyalkyl, mercapto, nitro, and alkylthio. Where the aryl group is a phenyl group, the number of substituents is 0, 1, 2, 3, 4, or 5. Where the aryl group is a bicyclic aryl, the number of substituents is 0, 1, 2, 3, 4, 5, 6, 7, 8, or 9. Where the aryl group is a tricyclic aryl, the number of substituents is 0, 1, 2, 3, 4, 5, 6, 7, 8, or 9.

The term “arylalkyl” as used herein means an aryl group, as defined herein, appended to the parent molecular moiety through an alkyl group, as defined herein. Representative examples of arylalkyl include, but are not limited to, benzyl, 2-phenylethyl and 3-phenylpropyl.

The term “heteroaryl” as used herein may be monocyclic or bicyclic. The carbon atoms of the heteroaryl group may be optionally substituted with one or more substituents independently selected from acyl, acyloxy, alkenyl, alkoxy, alkoxyalkoxy, alkoxyalkyl, alkoxycarbonyl, alkoxyimino, alkoxysulfonyl, alkyl, alkylcarbonyl, alkylsulfonyl, alkynyl, amido, carboxy, cyano, cycloalkyl, fluoroalkoxy, formyl, haloalkoxy, haloalkyl, halogen, hydroxy, hydroxyalkyl, mercapto, nitro, and alkylthio. Monocyclic heteroaryl or 5- or 6-membered heteroaryl rings are substituted with 0, 1, 2, 3, 4, or 5 substituents. Bicyclic heteroaryl or 8- to 12-membered bicyclic heteroaryl rings are substituted with 0, 1, 2, 3, 4, 5, 6, 7, 8, or 9 substituents. Heteroaryl groups of the present invention may be present as tautomers.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

According to the first aspect of the present disclosure, a coating composition is provided, comprising at least one film-forming resin, at least one co-solvent and at least one additive, wherein the at least one additive includes at least one fused aza-heterocyclic compound or at least one aza-heterocyclic compound substituted with at least one aromatic group, and the at least one fused aza-heterocyclic compound or the at least one aza-heterocyclic compound substituted with the at least one aromatic group having a ring containing at least one —NH— bond. The coating composition described herein can form a dense film with excellent water resistance and chemical resistance.

It is known in the art that the at least one fused aza-heterocyclic compound and the at least one aza-heterocyclic compound substituted with at least one aromatic group themselves have a special π electron aromatic ring. In this disclosure, the at least one fused aza-heterocyclic compound or the at least one aza-heterocyclic compound substituted with at least one aromatic group also have at least one ring containing at least one —NH— bond, in addition to the special π electron aromatic ring. The at least one fused aza-heterocyclic compound or the at least one aza-heterocyclic compound substituted with at least one aromatic group in this disclosure may also be an amine compound containing at least one benzene ring.

In some embodiments, the at least one fused aza-heterocyclic compound or the at least one aza-heterocyclic compound substituted with at least one aromatic group may have a structure with five-membered aza-heterocyclic ring and/or a structure with six-membered aza-heterocyclic ring.

In some embodiments, the at least one fused aza-heterocyclic compound or the at least one aza-heterocyclic compound substituted with the at least one aromatic group has a structure with five-membered aza-heterocyclic ring. The aza-heterocyclic structure may have one or more nitrogen atoms. In some embodiments, the at least one aza-heterocyclic structure may have 2 to 3 nitrogen atoms. In one embodiment, the at least one aza-heterocyclic structure may have 3 nitrogen atoms.

In the at least one fused aza-heterocyclic compound and the at least one aza-heterocyclic compound substituted with at least one aromatic group as described herein, the five-membered aza-heterocyclic ring may be fused or chemically bonded with at least one benzene ring, wherein the at least one benzene ring may be optionally substituted or optionally comprise nitrogen (optionally aza-benzene ring). In some embodiments, the at least one benzene ring is unsubstituted. In some embodiments, the at least one benzene ring is unaze- (does not comprise nitrogen). In some embodiments, the at least one benzene ring is unsubstituted and unaze-.

In some other embodiments, in the at least one fused aza-heterocyclic compound or the at least one aza-heterocyclic compound substituted with at least one aromatic group, the at least one benzene ring is substituted. For example, the at least one benzene ring is substituted with one or more of hydroxyl, alkyl, alkylamino, alkylcarbonyl, alkylsulfonyl, alkoxy, alkoxycarbonyl, alkoxyalkyl, alkoxyimino, alkoxysulfonyl, alkylthio, cycloalkyl, acyl, halogen, haloalkyl, haloalkoxy, hydroxyalkoxy, aryl, arylalkyl and heteroaryl. In some embodiments, the at least one benzene ring may be substituted with one or more of alkyl, alkyl amino, cycloalkyl, halogen, haloalkyl, haloalkoxy, aryl, arylalkyl and heteroaryl.

In some embodiments, in the at least one fused aza-heterocyclic compound or the at least one aza-heterocyclic compound substituted with an aromatic group, the at least one benzene ring may contain one or more nitrogen atoms (may be one or more aza-). In some embodiments, the at least one benzene ring contains one or two nitrogen atoms (is one or two aza-).

In the at least one fused aza-heterocyclic compound, the at least one aza-heterocyclic ring is fused with at least one benzene ring. In some embodiments, the at least one fused aza-heterocyclic compound may comprise one or any combination of benzotriazole

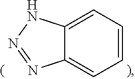

benzimidazole

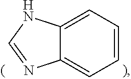

indole

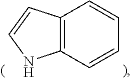

purine

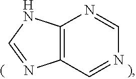

and phthalimide

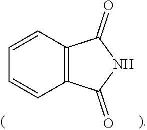 [SMILES: O=C1NC(=O)c2ccccc21]

In some embodiments, the at least one fused aza-heterocyclic compound comprises one or any combination of benzotriazole, benzimidazole and indole. In some embodiments, the at least one fused aza-heterocyclic compound comprises benzotriazole and/or benzimidazole. In one embodiment, the at least one fused aza-heterocyclic compound comprises benzotriazole. As described above, the at least one benzene ring may be optionally substituted or optionally aza-. Some of the embodiments of substituents are as described above.

In the at least one aza-heterocyclic compound substituted with at least one aromatic group, at least one aza-heterocyclic ring may be chemically bonded with at least one aromatic group. The at least one aromatic group may have one or more benzene ring structural moieties. In some embodiments, the at least one aza-heterocyclic compound substituted with at least one aromatic group may be an aza-heterocyclic compound substituted with a phenyl group. In some embodiments, the at least one aza-heterocyclic compound substituted with an aromatic group may include one or more of 2-phenylimidazole

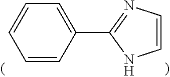 [SMILES: c1ccc(-c2ncc[nH]2)cc1]

and 2-phenyl-4-methylimidazole

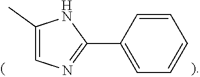

In the at least one aza-heterocyclic compound substituted with at least one aromatic group, the at least one benzene ring may be optionally substituted or optionally aza-. Some of the embodiments of substituent are as described above.

It has been surprisingly found that the film formed by curing the coating composition can have improvements of properties, such as resistance and hardness, by using the fused aza-heterocyclic compound or the aza-heterocyclic compound substituted with an aromatic group having a ring containing —NH— bond, especially the embodiments as described herein. The improvement of resistance may comprise the improvement of chemical resistance, such as at least one of alcohol resistance, acid resistance, water resistance and heat resistance, especially alcohol and/or water resistance. By applying some embodiments described herein, the obtained film has comparable or even better resistance, and more preferably an improved hardness, compared with the film obtained by using a crosslinking agent (such as polycarbodiimide, also referred to as PCDI). It can be seen that the fused aza-heterocyclic compound or the aza-heterocyclic compound substituted with an aromatic group described herein, especially with its embodiments described herein and amounts, can be used to form a dense film that can be formed by using conventional crosslinking agent before the present disclosure. This is unexpected to those skilled in the art.

Without wishing to be bound by theory, it is believed that when combined with at least one film-forming resin or emulsion, the at least one —NH— bond in the at least one fused aza-heterocyclic compound or the at least one aza-heterocyclic compound substituted with the at least one aromatic group can react with the polymeric chain of the at least one film-forming resins. As a result, the at least one aromatic group and the at least one aza-heterocyclic ring are introduced into the polymer chain, which improves the hydrophobicity of the film and the denseness of the film, thereby improving the durability of the film.

Based on the total weight of the coating composition, the amount of the at least one fused aza-heterocyclic compound or the at least one aza-heterocyclic compound substituted with an aromatic group may be 0.02-3 wt. %, 0.05-2.5 wt. %, 0.1-2 wt. %, and 0.2-1 wt. %. It has also been surprisingly found that the hardness and durability of the film may be significantly improved only by using a very low amount of the at least one fused aza-heterocyclic compound or the at least one aza-heterocyclic compound substituted with at least one aromatic group. Moreover, by using the above amounts, the cured film has further improved overall properties (including not only hardness and resistance, but also other paint film properties, such as transparency). It has also found that when the amount of the at least one fused aza-heterocyclic compound or the at least one aza-heterocyclic compound substituted with at least one aromatic group is further increased, such as 3% by weight or higher, the transparency of the film is significantly reduced.

The coating composition described herein comprises at least one film-forming resin. In this disclosure, film-forming resin refers to a resin that can form a film when the coating is cured. Various types of film-forming resins can be used. Examples of common film-forming resins include self-crosslinking resin, polyurethane resin, polyurethane acrylate resin, alkyd resin, acrylic resin, isocyanate resin, polyurethane acrylate modified epoxy resin, unsaturated polyester resin, acrylated epoxy resin and nitro resin. In many embodiments, the film-forming resin comprises one or more of self-crosslinking resin, polyurethane resin, polyurethane acrylate resin, alkyd resin and acrylic resin. In some embodiments, the film-forming resin comprises one or more of self-crosslinking resin, polyurethane resin and polyurethane acrylate resin.

In some embodiments, the film-forming resin comprises a self-crosslinking resin. Self-crosslinking resin refers to a resin that can be crosslinked without adding crosslinking agent. Examples of a self-crosslinking resin include self-crosslinking polyester resins, self-crosslinking polyamide resins, self-crosslinking acrylic resins, self-crosslinking epoxy resins, and self-crosslinking olefin resins. In one embodiment, the self-crosslinking resin comprises a self-crosslinking acrylic resin. In an exemplary embodiment, the self-crosslinking resin comprises an acrylic siloxane resin.

Self-crosslinking resins can be obtained from monomers with self-crosslinking groups. For example, self-crosslinking acrylic resins can be prepared from functional monomers containing a ketone carbonyl or epoxy group and hydrazide compounds. Examples of the functional monomers containing a ketone carbonyl or epoxy group may comprise, for example, diacetone acrylamide (DAAM), methyl vinyl ketone, ethyl acetoacetate methacrylate (AAEM), glycidyl methacrylate (GMA), acetamidoethyl (meth)acrylate, etc. In some embodiments, the functional monomer containing a ketone carbonyl group comprises one or more of DAAM, AAEM and GMA. In other embodiments, the functional monomer containing a ketone carbonyl group comprises DAAM, AAEM or a combination of the two.

Due to low toxicity and simple raw materials for synthesis and its benefit to enhancing the adhesion of coatings, DAAM is mostly used as a functional monomer containing ketone carbonyl group. In an exemplary embodiment, the functional monomer containing ketone carbonyl group comprises DAAM. In another exemplary embodiment, the functional monomer containing ketone carbonyl group comprises AAEM.

Examples of hydrazide compounds may include, for example, adipic dihydrazide (ADH), succinic dihydrazide, carbohydrazide, oxalylhydrazide, N(CH₂CH₂CONHNH₂)₃ and (H₂NHNCOCH₂CH₂)₂NCH₂CH₂N(CHCHCONHNH₂)₂, and polymeric polyhydrazides.

Self-crosslinking acrylic resin may be obtained by synthetic method. For example, self-a crosslinking polyacrylate emulsion (PAE) with seal function may be synthesized by semi continuous seeded emulsion polymerization using diacetone acrylamide (DAAM), methyl methacrylate (MMA), butyl acrylate (BA) and methacrylic acid (MAA) as co-monomers.

Self-crosslinking acrylic resin may be commercially available, for example, as self-crosslinking acrylic emulsion. Examples of commercially available self-crosslinking acrylic emulsion include, but are not limited to, ROSHIELD™ 3311 and ROSHIELD™ 3188.

In some embodiments, the film-forming resin comprises a polyurethane resin. Various types of polyurethane resins may be used. The polyurethane resin may be in the form of polyurethane dispersion (PUD). For example, U Series (such as U 6150, U 9380 and U 9900) commercially available from Alberdingk Boley, Inc., Bayhydrol series (such as Bayhydrol® UH 2558 and Bayhydrol® UH 2606) and Dispercoll series commercially available from Bayer, NeoRez series (such as NeoRez® R-2180, NeoRez® R-2005, NeoRez® R-9029 and NeoRez® R-2190) commercially available from DSM, SYNTEGRA series commercially available from Dow or Sancure series (such as Sancure 843, Sancure 898 and Sancure 12929) commercially available from Lubrizol, Inc. (Cleveland, OH) may be used.

In some embodiments, the film-forming resin comprises a polyurethane acrylate (PUA) resin. Various types of polyurethane acrylate resins may be used. For example, Hybridur series (such as Hybridur 870 and Hybridur 878) commercially available from Air Products, Inc., APU series (APU 10140, APU 10600 and APU 10620) commercially available from Alberdingk Boley, Inc., NeoPac® series (NeoPac R-9036 and NeoPac E-129) commercially available from DSM, CONFON 7005 commercially available from Confon Chemical Technology Co., Ltd., or PROSPERSE™ 100 commercially available from DOW may be used.

In some embodiments, the at least one film-forming resin has at least one side chain comprising ketone carbonyl (—(C═O)—) and/or epoxy group. In one embodiment, the at least one side chain of the polymer comprises a ketone carbonyl group.

Based on the total weight of the coating composition, the amount of film-forming resin may be about 45-95 wt. %, about 50-90 wt. %, about 60-85 wt. %, and about 65-80 wt. %.

The coating composition described herein also comprises at least one co-solvent. In the coating composition, the at least one co-solvent may be an organic solvent commonly used in the art. For example, the co-solvent may be one or at least two of alkyl alcohols, alcohol ethers, ketones or esters. Examples of co-solvent include, but are not limited to, ethanol, isopropanol, butanol, butoxydiglycol, butyl glycol, dipropylene glycol methyl ether (DPM), propylene glycol methyl ether, ethylene glycol butyl ether, dipropylene glycol butyl ether (DPnB), ethylene glycol ethyl ether, ethylene glycol monomethyl ether, ethylene glycol monohexyl ether, ethylene glycol monon-butyl ether, diethylene glycol monomethyl ether, diethylene glycol monon-butyl ether tripropylene glycol monomethyl ether, ethylene alcohol monoisobutyl ether, diethylene glycol monoisobutyl ether, propylene glycol monoisobutyl ether, ethylene glycol monophenyl ether, propylene glycol monophenyl ether, ethylene glycol monomethyl ether acetate, acetone, methyl ethyl ketone, methyl isobutyl ketone, cyclohexanone, toluene, xylene, trimethylbenzene, solvent naphtha-100, 2-methylpropyl acetate, n-butyl acetate, or any combination thereof.

Based on the total weight of the coating composition, the amount of co-solvent may be about 4-10 wt. %, about 5-9 wt. %, about 6-8 wt. %. For example, the amount of co-solvent can be even about 6.5 wt. %, 7 wt. %, 7.5 wt. % or 8 wt. %, based on the total weight of the coating composition.

In some embodiments, based on the total weight of the coating composition, the amount of water may be about 5-40 wt. %, about 8-35 wt. %, about 10-30 wt. %. For example, based on the total weight of the coating composition, the amount of water may be about 12, 13, 14, 15, 16, 18, 20, 22 or 25 wt. %.

The coating composition of the application can also optionally contain at least one pigment, other additives, or any combinations thereof.

In some embodiments, the pigments may be in shape of sphere, fiber, flake, or other regular or irregular shapes of micrometric or even nanometric size. Suitable examples of pigments include metal oxides such as titanium dioxide, iron oxides, zinc oxide, zirconia, or aluminia; metal composite oxides containing two or more metal elements including manganese, nickel, titanium, chromium, antimony, magnesium, cobalt, iron, or aluminum; oxymetallic compounds, such as bismuth vanadate, cobalt aluminate, cobalt zincate, or zinc chromate; metallic pigments, such as aluminum flake, copper, and copper-zinc alloys; and pearlescent pigments, such as lead carbonate and bismuth oxychloride; talc; and any combinations thereof. In some embodiments, the at least one pigment is titanium dioxide. In one embodiment, the titanium dioxide is in powder form. In one embodiment, the at least one pigment comprises rutile titanium dioxide. These pigments may be commercially available. For example, titanium dioxide pigment BLR-688 available from Billions may be used as an example of the pigment.

The total amount of the at least one pigment may be from 0 wt. % to 50 wt. %, for example, from 1 wt. % to 45 wt. %, from 2 wt. % to 40 wt. %, from 3 wt. % to 35 wt. %, from 4 wt. % to 30 wt. %, from 5 wt. % to 25 wt. %, from 10 wt. % to 20 wt. %, based on the total weight of the coating composition. Further, the amount of each pigment may be independently of from 0 wt. % to 50 wt. %, from 1 wt. % to 40 wt. %, from 2 wt. % to 30 wt. %, from 3 wt. % to 20 weight. %, or from 4 wt. % to 15 wt. %, based on the total weight of the coating composition.

The coating composition described herein also comprises at least one additive. In the coating compositions, optional other additives may be those commonly used in coating compositions. Those additives do not adversely affect the coating composition or a cured coating resulting therefrom. Suitable additives include those agents which can, for example, improve the manufacturing, processing of the composition, enhance composition esthetics, improve a particular functional property or characteristics (for example, the adhesion to a substrate) of a coating composition or a cured coating resulting therefrom. Depending on the particular needs, the additives that may be present in the coating composition include, but not limited to, fillers, anti-skinning agents, driers, emulsifiers, anti-migration aids, antibacterial agents, chain extenders, lubricants, wetting agents, biocides, plasticizers, defoamers, colorants, waxes, antioxidants, anticorrosive agents, anti-freezing agents, rheological aids, thickeners, dispersants, adhesion promoters, UV stabilizers, pH adjusters, leveling agents or combinations thereof. The amount of each of optional ingredients is sufficient to achieve its intended purpose, but such amount does not adversely affect the coating composition or the cured coating derived therefrom.

In many embodiments, other additives comprise one or more of defoamers, leveling agents, thickeners and wetting agents. As an example of the leveling agents, BYK 358 available from BYK may be used. As an example of the defoamers, BYK-071 available from BYK may be used.

In some embodiments, relative to the total weight of the coating composition, the coating composition comprises about 0 to about 30 wt. %, about 0.1 to about 25 wt. % of other additives. Specifically, relative to the total weight of the coating composition, the amount of each other additive in the coating composition may be 0.1 wt. % to 10.0 wt. %, such as 0.2 wt. %, 0.3 wt. %, 0.4 wt. %, 0.6 wt. %, 0.7 wt. %, 0.8 wt. %, 0.9 wt. %, 1 wt. %, 1.1 wt. %, 1.2 wt. %, 1.3 wt. %, 1.4 wt. %, 1.5 wt. %, 1.8 wt. %, 2.0 wt. %, 2.5 wt. % 3.0 wt. %, 3.5 wt. %, 4.0 wt. %, 4.5 wt. %, 5.0 wt. %, 6.0 wt. %, 8.0 wt. %, or 9.0 wt. %.

Suitable thickeners include one or more of: cellulose thickener, alkali swelling thickeners, polyurethane thickeners, hydrophobically modified polyurethane thickeners and inorganic thickeners. The thickeners may be commercially available products. For example, as an example of cellulose thickener, hydroxyethyl cellulose thickener HEC 250 H4BR commercially available from ASHLAND Company, USA, may be used. As an example of alkali swelling thickener, ASE60 commercially available from Dow Chemical Co., USA may be used. RM-2050D commercially available from Dow Chemical Co., USA, U902 or U903 commercially available from Wanhua Chemical Group may be used as examples of polyurethane thickener. As an example of an inorganic thickener, bentonite can be used.

In some embodiments, the coating composition of the present invention may comprise about 0.1 wt. % to about 5.0 wt. %, about 0.5 wt. % to about 4.0 wt. %, 1.0 wt. % to 3.0 wt. % of a thickener, relative to the total weight of the coating composition. For example, the coating composition of the present invention comprises 1.2 wt. %, 1.5 wt. %, 2.0 wt. % or 2.5 wt. % of a thickener, relative to the total weight of the coating composition.

The coating composition of the present application may optionally comprise defoamers. Suitable defoamers may include one or more of organic siloxane defoamers, oil defoamers, polyether defoamers, and polyether-modified organic silicone defoamers. For example, non-ionic mineral oil may be used. All of these types of defoamers are commercially available products. As an example of defoamers, CF-246 commercially available from Blackburn Chemicals can be used.

In some embodiments, the coating composition described herein may comprise about wt. % to about 1.0 wt. %, about 0.3 wt. % to about 0.5 wt. % of a defoamer, relative to the total weight of the coating composition.

The coating composition described herein may be mono-component, meaning a one-part system. In some embodiments, based on the total weight of the coating composition, the coating composition comprises:
50-90 wt. % of the at least one film-forming resin;
4-10 wt. % of the at least one co-solvent;
5-40 wt. % of water; and
0.1-1 wt. % of the at least one fused aza-heterocyclic compound or the at least one aza-heterocyclic compound substituted with at least one aromatic group.

Further, based on the total weight of the coating composition, the coating composition may further comprise 0.1-1 wt. % of other additive(s), including one or more of defoamer, leveling agent, thickener and wetting agent.

The coating composition described herein may also be multi-component, such as a two-component system. In an exemplary embodiment, multi-component coating composition comprises: A) the coating composition described above; B) at least one crosslinking agent. It has also been found that in some embodiments, the use of crosslinking agent can stabilize the improvement of resistance of film, or even further improve the resistance of the film.

In the coating composition described herein, the crosslinking agent may be free of or substantially be free of sensitizing substances (such as aziridine and the like).

The crosslinking agent may comprise a compound having —N═C═N— or epoxy functional group. In some embodiments, the at least one crosslinking agent comprises at least one carbodiimide compound, at least one silane compound, or a combination thereof. It has also been found that the combination of two or more crosslinking agents may stabilize the improvement of the resistance of the film, or even further improve the resistance of the film.

The at least one carbodiimide compound has at least one —N═C═N—. As the at least one carbodiimide-group-containing compound, a polycarbodiimide compound containing at least two carbodiimide groups per molecule or carbodiimide-derived moieties may be used. In one embodiment, the carbodiimide compound has at least three carbodiimide groups per molecule. For example, in some exemplary embodiments, the carbodiimide compound has 3 to 7 carbodiimide groups. The carbodiimide compound may include aliphatic carbodiimide compounds, alicyclic carbodiimide compounds, or aromatic carbodiimide compounds.

The at least one carbodiimide compound may be water-soluble or water-dispersible. There is no particular limitation to the water-soluble or water-dispersible polycarbodiimide compounds so long as the polycarbodiimide compounds are stably dissolved or dispersed in an aqueous medium. Examples of the water-soluble or water-dispersible polycarbodiimide compounds include CARBODILITE SV-02, CARBODILITE V-02, CARBODILITE V-02-L2, CARBODILITE V-04, CARBODILITE E-01, CARBODILITE E-02 and CARBODILITE E-05 (names of products commercially available from Nisshinbo Industries, Inc.), and the like. Such polycarbodiimide compounds can be used singly or in a combination of two or more.

Further, at least one carbodiimide compound may also be synthesized by common well-known methods. For example, carbodiimide compounds may also be synthesized by decarboxylation condensation of various polyisocyanates at a temperature above about 70° C. in a solvent-free or inert solvent using organophosphorus compounds or organometallic compounds as catalysts.

In some embodiments, at least one silane compound may be used as crosslinking agents. In one embodiment, the silane compound is an epoxy silane compound. The epoxy silane compound may have an epoxy equivalent in the range of 4 to 6 meq/g.

In some embodiments, the epoxy silane compound is an epoxy silane oligomer of the following Formula (I)

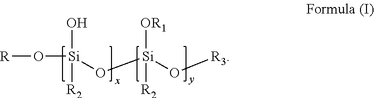

In Formula (I), R and R₁ are independently substituted or unsubstituted alkyl groups; R₂ is independently a substituted or unsubstituted linear, branched or cyclic alkyl or an alkyl ether residue substituted by an epoxide; R₃ is hydrogen or substituted or unsubstituted alkyl, and x+y≥2, x≥0.

In Formula (I), R and R₁ are independently C₁₋₁₀ alkyl (such as, linear or branched C₁₋₁₀ alkyl), including an alkyl substituted with aryl (i.e., an arylalkyl). For example, R and R₁ are independently methyl or ethyl. In some embodiments, R and R₁ are independently substituted or unsubstituted arylalkyl groups having at least 7 carbon atoms, such as substituted or unsubstituted benzyl groups.

R₂ is an alkyl ether residue substituted with epoxide, or a substituted or unsubstituted linear, branched or cyclic alkyl group with less than or equal to 30 carbon atoms.

R₃ is hydrogen or a substituted or unsubstituted alkyl (linear or branched, including cycloalkyl) or unsubstituted arylalkyl.

The sum of x and y is at least 3.

For example, useful epoxy silane compounds have the following structures:

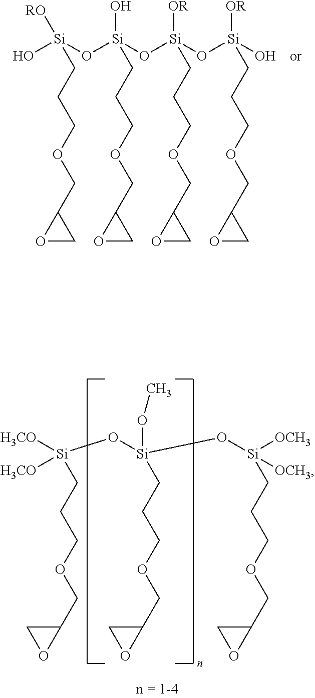

in which, R is C₁₋₁₀ alkyl (e.g., linear or branched), including an alkyl substituted with aryl (i.e., arylalkyl). For example, R is independently methyl or ethyl.

Exemplary epoxy silane compounds include, for example, commercially available CoatOSil MP 200.

The amount of at least one crosslinking agent can be appropriately adjusted according to the type of crosslinking agent, film-forming resin and desired film properties. Based on the total weight of the multicomponent coating composition, the amount of at least one crosslinking agent may be about 0.3 wt. % to 8 wt. %, about 0.5 wt. % to 6 wt. %, about 1 wt. % to 5 wt. %. For example, based on the total weight of the multicomponent coating composition, the amount of at least one crosslinking agent may be about 1.2 wt. %, about 2 wt. %, about 3 wt. %, or about 4 wt. %.

In some embodiments, the weight ratio of the at least one crosslinking agent to the at least one fused aza-heterocyclic compound or the at least one aza-heterocyclic compound substituted with the at least one aromatic group is 1.1:1 to 10:1. In some embodiments, the weight ratio of the crosslinking agent to the fused aza-heterocyclic compound or the aza-heterocyclic compound substituted with an aromatic group is 1.2:1 to 8:1. In other embodiments, the weight ratio is 1.5:1 to 5:1. For example, the weight ratio of the crosslinking agent to the fused aza-heterocyclic compound or the aza-heterocyclic compound substituted with an aromatic group may be about 2:1, about 2.5:1, about 3:1, about 3.5:1, or about 4:1.

The preparation of the coating composition of the invention can be accomplished by any appropriate mixing method well known to those skilled in the art. For example, the coating composition can be made by the follows step of: adding at least one film-forming resin or emulsion, at least one co-solvent and at least one additive to the container, then stirring the mixture to until homogeneous. Alternatively, the coating composition may be made by first mixing some of the additives (such as the at least one fused aza-heterocyclic compound or the at least one aza-heterocyclic compound substituted with the at least one aromatic group) with at least one co-solvent and then adding at least one film-forming resin or emulsion and the rest of the additives to form a homogeneous mixture. Water may be added during the preparation of the coating composition.

The aqueous coating composition may be applied by conventional methods known to those skilled in the art. In many embodiments, the coating composition is applied by brushing, spraying and other coating methods known in the art. In this way, a coating can be formed from the coating composition of the present application, and the resulting coating also falls within the protection scope of the present application. Thus, the present application also provides a coating that can be obtained from the coating composition described herein.

The coating composition described herein is suitable for use in wood, metal, plastic, inner and outer wall applications. It is particularly suitable for use as a wood coating composition.

A second aspect of the present application provides a coated article, comprising a substrate; and a coating composition or a cured coating formed by the coating composition as described herein, coated on the substrate.

Examples of substrate may be selected from one or more of wood, metal, plastic, cement board, inner wall, and outer wall. Examples of suitable substrate materials include wood, cement, cement fiber board, wood-plastic composites, tile, metal, plastic, glass, and fiberglass. In many embodiments, the coating composition is particularly suitable for use on wood substrates. Suitable wood substrates include substrates derived from wood materials such as oak (e.g., white oak and red oak), pine (e.g., white pine and southern yellow pine), poplar, spruce, cherry, walnut, redwood, cedar, maple, mahogany, birch, hickory, walnut, ash, and the like. In many embodiments, wood materials for the wood substrate include those that exhibit light colors and are susceptible to UV-light discolorations, such as oak, pine, maple, and the like. In addition, the wood substrate may be an engineered wood product, in which the substrate is prepared from wood pieces (e.g., sheets, chips, flakes, fibers, strands).

Unless otherwise specified, the various features described herein and the corresponding preferred methods can be combined.

### EXAMPLES

The present application is more particularly described in the following examples that are intended as illustrations only. Embodiments of the invention are not limited to these specific examples. Unless otherwise noted, all parts, percentages, and ratios reported in the following examples are on a weight basis. In addition, all reagents used in the examples are commercially available and used directly without further treatment. For example, in the following examples, CARBODILITE E-05 is a commercially available PCDI product. Those skilled in the art can easily purchase or prepare the raw materials used in the embodiment.

Test Methods

Pencil hardness was measured by using a pencil hardness tester according to ASTM D3363 standard.

Chemical resistance (or liquid resistance), including the resistance of a film to ethanol, acetic acid, water and hot water, was measured by using the corresponding test time according to GB/T 4893.1. The results were evaluated according to the grading standard, in which 5=the best and 0=the worst.

### Example 1

The components were mixed with their amounts as shown in Table 1. STD 1 sample was used as control and did not contain a fused aza-heterocyclic compound or an aza-heterocyclic compound substituted with an aromatic group as additive. Samples 1, 2 and 3 respectively contained the same amount of aza-heterocyclic additives, in which TINUVIN 1130 is a benzotriazole compound having no —NH— bond on the heterocyclic ring; 1,2,3-triazole does not have a fused ring structure containing —NH— bond.

TABLE 1

| Materials | STD 1 | Sample 1 | Sample 2 | Sample 3 |
|---|---|---|---|---|
| Dow 3311 | 75 | 75 | 75 | 75 |
| DPM | 3 | 3 | 3 | 3 |
| DPnB | 3.5 | 3.5 | 3.5 | 3.5 |
| Defoamer | 1.7 | 1.7 | 1.7 | 1.7 |
| Leveling agent | 0.3 | 0.3 | 0.3 | 0.3 |
| Thickener | 0.6 | 0.6 | 0.6 | 0.6 |
| Rheological aid | 0.14 | 0.14 | 0.14 | 0.14 |
| Water | 15.76 | 14.76 | 14.76 | 14.76 |
| TINUVIN 1130 | / | 1 | / | / |
| Benzotriazole | / | / | 1 | / |
| 1,2,3- triazole | / | / | / | 1 |
| Total | 100 g | 100 g | 100 g | 100 g |

Each of the samples was applied on wood. After the surface was touch dry, the sample was baked at 40° C. for 2 hours, and then dried at room temperature for 7 days. The properties of the resulting films were tested. The results were shown in Table 2.

TABLE 2

| | | Chemical resistance | | | |
|---|---|---|---|---|---|
| | Pencil | Ethanol | 10% acetic | Water | Hot water |
| | hardness | (1 h) | acid (24 h) | (24 h) | (20 min) |
| STD 1 | HB | 3 | 2 | 2.5 | 3 |
| Sample 1 | HB | 3.5 | 2.5 | 3 | 3 |
| Sample 2 | F | 3.5 | 4 | 3 | 3.5 |
| Sample 3 | HB | 2.5 | 2.5 | 2 | 3 |

It can be seen from Table 2 that: The film of sample 1 with TINUVIN 1130 exhibited resistance to alcohol, acid and water which was improved to a certain extent; The film of sample 2 with benzotriazole exhibited significantly improved resistance to alcohol, acid, water and hot water, and also exhibited especially prominent improvements in hardness, acid resistance and heat resistance; Sample 3 with 1,2,3-triazole exhibited an improved acid resistance, but a deteriorated alcohol and water resistance. The experimental results show that benzotriazole can significantly improve the performance of the film, and is much better than TINUVIN 1130 and 1,2,3-triazole in the comprehensive performance of the film.

### Example 2: Two-Component Coating Composition

The coating compositions were prepared in a similar manner to Example 1, except that component B was also contained. The components with their amounts shown in Table 3 were mixed. STD 2 sample was used as a control and did not contain a fused aza-heterocyclic compound or an aza-heterocyclic compound substituted with an aromatic group as additive.

TABLE 3

| | Materials | STD 2 | | Sample 4 | | Sample 5 | | Sample 6 | |
|---|---|---|---|---|---|---|---|---|---|
| Component A | Dow 3311 | 75 | | 75 | | 75 | | 75 | |
| | DPM | 3 | | 3 | | 3 | | 3 | |
| | DPnB | 3.5 | | 3.5 | | 3.5 | | 3.5 | |
| | Defoamer | 1.7 | | 1.7 | | 1.7 | | 1.7 | |
| | Leveling agent | 0.3 | | 0.3 | | 0.3 | | 0.3 | |
| | Thickener | 0.5 | | 0.5 | | 0.5 | | 0.5 | |
| | Rheological aid | 0.14 | | 0.14 | | 0.14 | | 0.14 | |
| | Water | 15.76 | | 14.76 | | 14.76 | | 14.76 | |
| | TINUVIN 1130 | / | | 1 | | / | | / | |
| | Benzotriazole | / | | / | | 1 | | / | |
| | 1,2,3- triazole | / | | / | | / | | 1 | |
| | Total | 100 | g | 100 | g | 100 | g | 100 | g |
| Component B | PCDI | 3 | g | 3 | g | 3 | g | 3 | g |

Each of the samples was applied on wood. After the surface was touch dry, the sample was baked at 40° C. for 2 hours, and then dried at room temperature for 7 days. The properties of the resulting films were tested. The results were shown in Table 4.

TABLE 4

| | | Chemical resistance | | | |
|---|---|---|---|---|---|
| | Pencil | Ethanol | 10% acetic | Water | Hot water |
| | hardness | (1 h) | acid (24 h) | (24 h) | (20 min) |
| STD 2 | HB | 3 | 2 | 2.5 | 4 |
| Sample 4 | HB | 3 | 2 | 2.5 | 5 |
| Sample 5 | F | 4 | 4 | 4 | 5 |
| Sample 6 | HB | 4 | 4 | 2 | 4 |

It can be seen from comparison between Table 2 and Table 4 that adding crosslinking agent PCDI further improve the performance of film. The results show that the coating formed by the coating composition containing benzotriazole (Sample 5) still exhibited much better film properties, especially water resistance of the film.

It should be noted that even compared with the two-component coating composition added with PCDI (control sample STD 2 shown in Example 2), the film added with benzotriazole as the one-component coating composition (Sample 2 shown in example 1) still showed much better properties, such as hardness of grade F and significantly better resistance to alcohol, acid, water and hot water.

### Example 3: Effects of Different Fused Aza-Heterocyclic Compounds or Aza-Heterocyclic Compounds Substituted with an Aromatic Group

The coating compositions were prepared in a similar manner to Examples 1 and 2, except that the resins, fused aza-heterocyclic compounds or the aza-heterocyclic compounds substituted with an aromatic group and crosslinking agents shown in Table 5 below were used, where “N” means no PCDI was added, and “Y” means 3 g PCDI was added as component B. Each of the samples was applied on wood. After the surface was touch dry, the sample was baked at 40° C. for 2 hours, and then dried at room temperature for 7 days. The properties of the resulting films were tested. The results were shown in Table 5.

TABLE 5

| | Chemical resistance | | | | |
|---|---|---|---|---|---|
| | PCDI | Ethanol | 10% acetic | Water | Hot water |
| | (Y/N) | (1 h) | acid (24 h) | (24 h) | (20 min) |
| DOW 3311 (ADH/DAAM) | N | 3 | 2 | 2.5 | 3 |
| | Y | 3 | 2 | 2.5 | 4 |
| DOW 3311 + benzotriazole | N | 3.5 | 4 | 3 | 3.5 |
| | Y | 4 | 4 | 4 | 5 |
| DOW 3311 + benzimidazole | N | 3.5 | 4 | 3 | 3.5 |
| | Y | 4 | 4 | 4 | 4.5 |
| DOW 3311 + 2-phenylimidazole | N | 3.5 | 3.5 | 3 | 3.5 |
| | Y | 4 | 4 | 4 | 4 |
| DOW 3311 + indole | N | 3.5 | 4 | 3 | 3.5 |
| | Y | 4 | 4 | 3.5 | 4.5 |

The results shows that benzotriazole, benzimidazole, 2-phenylimidazole and indole can improve the resistance of films. Moreover, after adding PCDI crosslinking agent, the resistance to alcohol, water and hot water was further improved. The film with benzotriazole still showed the best comprehensive chemical resistance.

### Example 4: Using Different Crosslinking Agents

Each of coating compositions were prepared in a similar manner to Example 3, except that the CoatOSil MP 200 epoxy silane compound shown in Table 6 below was used as component B with its amounts. Each of the samples was applied on wood. After the surface was touch dry, the sample was baked at 40° C. for 2 hours, and then dried at room temperature for 7 days. The properties of the resulting films were tested. The results were shown in Table 6.

TABLE 6

| | Chemical resistance | | | | | |
|---|---|---|---|---|---|---|
| | | | | 10% | | |
| | 1% MP | | 10% | acetic | | Hot |
| | 200 | Ethanol | Na₂CO₃ | acid | Water | water |
| | (Y/N) | (1 h) | (24 h) | (24 h) | (24 h) | (20 min) |
| DOW 3311 | N | 3 | 4 | 2 | 2.5 | 3 |
| (ADH/DAAM) | Y | 4 | 4 | 4 | 3.5 | 3.5 |
| DOW 3311 + | N | 3.5 | 4 | 4 | 3 | 3.5 |
| benzotriazole | Y | 4.5 | 4.5 | 4 | 4.5 | 4.5 |

The results shows that in the sample containing added benzotriazole, adding epoxy silane compound as crosslinking agent can further improve the resistance of film to alcohol, water and hot water, and improve alkali resistance of film.

### Example 5: Using Different Film-Forming Resins

Each of coating compositions were prepared in a similar manner to Examples 1-4, except that the film-forming resins shown in Table 7 below was used. Each of the samples was applied on wood. After the surface was touch dry, the sample was baked at 40° C. for 2 hours, and then dried at room temperature for 7 days. The properties of the resulting films were tested. The results were shown in Table 7.

TABLE 7

| | Chemical resistance | | | | |
|---|---|---|---|---|---|
| | PCDI | Ethanol | 10% acetic | Water | Hot water |
| | (Y/N) | (1 h) | acid (24 h) | (24 h) | (20 min) |
| DOW 3311 (ADH/DAAM) | N | 3 | 2 | 2.5 | 3 |
| | Y | 3 | 2 | 2.5 | 4 |
| DOW 3311 + benzotriazole | N | 3.5 | 4 | 3 | 3.5 |
| | Y | 4 | 4 | 4 | 5 |
| DOW 3188 (AAEM/ADH) | N | 3.5 | 3.5 | 3.5 | 4 |
| | Y | 3.5 | 3.5 | 4 | 5 |
| DOW 3188 + benzotriazole | N | 4 | 3.5 | 4 | 4 |
| | Y | 4 | 4 | 4.5 | 5 |
| DSM E129 (PUA) | N | 3.5 | 3.5 | 4 | 4 |
| | Y | 4 | 3.5 | 4 | 4.5 |
| DSM E129 (PUA) + benzotriazole | N | 4 | 4 | 4.5 | 4 |
| | Y | 4 | 4 | 4.5 | 5 |
| DSM R2180 (PUD) | N | 3.5 | 3.5 | 3.5 | 4 |
| | Y | 3.5 | 4 | 4 | 4 |
| DSM R2180 (PUD) + benzotriazole | N | 4 | 4 | 4 | 4 |
| | Y | 4 | 4 | 4.5 | 4.5 |

It can be seen from Table 7 that the addition of the fused aza-heterocyclic compound can significantly improve the film properties of many different film-forming resin systems after curing, especially in terms of alcohol resistance and water resistance. Moreover, in coating compositions containing different film-forming resins, all the combinations comprising the fused aza-heterocyclic compound and crosslinking agents described herein show the optimal comprehensive chemical resistance.

Through experiments, it has also been found that when the amount of a fused aza-heterocyclic compound or an aza-heterocyclic compound substituted with an aromatic group is further increased (greater than 3 wt. %), the transparency of the paint film is significantly reduced. In particular, this significant reduction in transparency can be distinguished with the naked eyes.

Some exemplary embodiments of the present invention are provided as follows:

Embodiment 1: A coating composition, comprising at least one film-forming resin, at least one co-solvent and at least one additive, wherein the at least one additive includes at least one fused aza-heterocyclic compound or at least one aza-heterocyclic compound substituted with at least one aromatic group, and the fused aza-heterocyclic compound or the aza-heterocyclic compound substituted with at least one aromatic group having at least one ring containing at least one —NH— bond.

Embodiment 2: An embodiment of Embodiment 1, wherein the at least one fused aza-heterocyclic compound or the at least one aza-heterocyclic compound substituted with at least one aromatic group has a structure with five-membered aza-heterocyclic ring.

Embodiment 3: An embodiment of Embodiment 2, wherein the five-membered aza-heterocyclic ring is fused or chemically bonded with at least one optionally substituted or optionally aza-benzene ring.

Embodiment 4: An embodiment of any one of Embodiments 1 to 3, wherein the at least one fused aza-heterocyclic compound comprises one or any combination of benzotriazole, benzimidazole, indole, purine and phthalimide.

Embodiment 5: An embodiment of any one of Embodiments 1 to 4, wherein the at least one aza-heterocyclic compound substituted with the at least one aromatic group comprises one or more of 2-phenylimidazole and 2-phenyl-4-methylimidazole.

Embodiment 6: An embodiment of any one of Embodiments 1 to 5, wherein the film-forming resin comprises one or any combination of self-crosslinking resin, polyurethane resin, polyurethane acrylate resin, alkyd resin, acrylic resin, isocyanate resin, polyurethane acrylate modified epoxy resin, unsaturated polyester resin, acrylated epoxy resin and nitro resin.

Embodiment 7: An embodiment of Embodiment 6, wherein the film-forming resin has at least one side chain comprising ketone carbonyl group.

Embodiment 8: An embodiment of any one of Embodiments 1 to 7, comprising: based on the total weight of the coating composition, 50-90 wt. % of the at least one film-forming resin; 4-10 wt. % of the at least one co-solvent; 5-40 wt. % of water; 0.1-1 wt. % of the at least one fused aza-heterocyclic compound or the at least one aza-heterocyclic compound substituted with the at least one aromatic group; and 0.1-1 wt. % of the at least one additive, including defoamer, leveling agent, thickener, wetting agent, or combinations thereof.

Embodiment 9: A multi-component coating composition, comprising: A) the coating composition according to any one of claims 1 to 8; and B) at least one crosslinking agent.

Embodiment 10: An embodiment of Embodiment 9, wherein the at least one crosslinking agent comprises at least one compound having a —N═C═N— group, an epoxy functional group, or combinations thereof.

Embodiment 11: An embodiment of Embodiment 10, wherein based on the total weight of the multi-component coating composition, the at least one crosslinking agent has an amount of from 1 wt. % to 5 wt. %.

Embodiment 12: A coated article, comprising: a substrate selected from one or more of wood, metal, plastic, cement board, inner wall and outer wall; and a cured coating formed by the coating composition according to any one of claims 1 to 8 or the multi-component coating composition according to any one of Embodiments 9 to 11, coated on the substrate.

While the invention has been described with respect to a number of embodiments and examples, those skilled in the art will appreciate that modifications may be made to the application without departing from the principles disclosed in the foregoing description. For example, without departing from the principles disclosed in the foregoing description, the technical solutions obtained by combining multiple features or preferred implementations described herein shall be understood to belong to the contents recorded herein. Such modifications are to be considered as included within the following claims unless the claims expressly state otherwise. Accordingly, the embodiments described in detail herein are illustrative only and do not intend to limit the scope of the invention which is to be given the full breadth of the appended claims and any and all equivalents thereof

What is claimed is:

1. A coating composition, comprising at least one film-forming resin, at least one co-solvent and at least one additive, wherein the at least one additive includes at least one fused aza-heterocyclic compound or at least one aza-heterocyclic compound substituted with at least one aromatic group, and the fused aza-heterocyclic compound or the aza-heterocyclic compound substituted with at least one aromatic group having at least one ring containing at least one —NH— bond.

2. The coating composition according to claim 1, wherein the at least one fused aza-heterocyclic compound or the at least one aza-heterocyclic compound substituted with at least one aromatic group has a structure with five-membered aza-heterocyclic ring.

3. The coating composition according to claim 2, wherein the five-membered aza-heterocyclic ring is fused or chemically bonded with at least one optionally substituted or optionally aza-benzene ring.

4. The coating composition according to claim 1, wherein the at least one fused aza-heterocyclic compound comprises one or any combination of benzotriazole, benzimidazole, indole, purine and phthalimide.

5. The coating composition according to claim 1, wherein the at least one aza-heterocyclic compound substituted with the at least one aromatic group comprises one or more of 2-phenylimidazole and 2-phenyl-4-methylimidazole.

6. The coating composition according to claim 1, wherein the film-forming resin comprises one or any combination of self-crosslinking resin, polyurethane resin, polyurethane acrylate resin, alkyd resin, acrylic resin, isocyanate resin, polyurethane acrylate modified epoxy resin, unsaturated polyester resin, acrylated epoxy resin and nitro resin.

7. The coating composition according to claim 6, wherein the film-forming resin has at least one side chain comprising ketone carbonyl group.

8. The coating composition according to claim 1, comprising: based on the total weight of the coating composition,
50-90 wt. % of the at least one film-forming resin;
4-10 wt. % of the at least one co-solvent;
5-40 wt. % of water;
0.1-1 wt. % of the at least one fused aza-heterocyclic compound or the at least one aza-heterocyclic compound substituted with the at least one aromatic group; and
0.1-1 wt. % of the at least one additive, including defoamer, leveling agent, thickener, wetting agent, or combinations thereof.

9. A multi-component coating composition, comprising:
A) the coating composition according to claim 1; and
B) at least one crosslinking agent.

10. The multi-component coating composition according to claim 9, wherein the at least one crosslinking agent comprises at least one compound having a —N═C═N— group an epoxy functional group, or combinations thereof.

11. The multi-component coating composition according to claim 10, wherein based on the total weight of the multi-component coating composition, the at least one crosslinking agent has an amount of from 1 wt. % to 5 wt. %.

12. A coated article, comprising:
a substrate selected from one or more of wood, metal, plastic, cement board, inner wall and outer wall; and
a cured coating formed by the coating composition according to claim 1.
